(19) United States
(12) Patent Application Publication
(10) Pub. No.: US 2013/0293043 A1
(43) Pub. Date: Nov. 7, 2013

(54) ELECTRO-MECHANICAL ROTATING MACHINE SPACER BLOCK

(71) Applicants: Ravindra Gopal Gardas, Solapur (IN); Radhakrishna Venkateswarlu Darbha, Hyderabad (IN)

(72) Inventors: Ravindra Gopal Gardas, Solapur (IN); Radhakrishna Venkateswarlu Darbha, Hyderabad (IN)

(73) Assignee: GENERAL ELECTRIC COMPANY, Schenectady, NY (US)

(21) Appl. No.: 13/464,117

(22) Filed: May 4, 2012

(51) Int. Cl. H02K 9/00

(52) U.S. Cl. 310/65

(57) ABSTRACT

An electro-mechanical rotating machine spacer block includes at least one base spacer portion having first and second lamination surfaces separated by an inner edge portion and an outer edge portion. The inner edge portion includes a concave curvilinear profile and the outer edge portion includes a convex curvilinear profile. A plurality of spacer finger members are integrally formed with and extend radially from one of the inner and the outer edge portions

### BACKGROUND OF THE INVENTION

The subject matter disclosed herein relates to the art of electro-mechanical rotating machine and, more particularly, to an electro-mechanical rotating machine spacer block.

Electro-mechanical rotating machines such as motors, generators and the like generally include a moveable member or rotor that is rotated relative to a fixed member or stator to produce an electrical current. During operation, both the stator and the rotor are subjected to high temperatures. In the stator, a cooling fluid is passed through passages formed between stator laminations. The passages are created by spacer plates that are arranged between select ones of the stator laminations. Similarly, during operation, the rotor experiences elevated temperatures and thus is provided with cooling. Rotor cooling is also accomplished by passing a cooling fluid through passages formed between adjacent rotor laminations. The passages are formed by spacer blocks arranged between select ones of the rotor laminations.

### BRIEF DESCRIPTION OF THE INVENTION

According to one aspect of the exemplary embodiment, an electro-mechanical rotating machine spacer block including at least one base spacer portion having first and second lamination surfaces separated by an inner edge portion and an outer edge portion. The inner edge portion includes a concave curvilinear profile and the outer edge portion includes a convex curvilinear profile. A plurality of spacer finger members are integrally formed with and extend radially from one of the inner and the outer edge portions.

According to another aspect of the exemplary embodiment, an electro-mechanical rotating machine includes a lamination member having first and second opposing surfaces defining an inner annular edge and an outer annular edge. The lamination member includes one or more openings extending through the first and second opposing surfaces, and one or more mounting features. A plurality of spacer blocks are joined to one of the first and second opposing surfaces through the mounting features without a thermal bonding process.

These and other advantages and features will become more apparent from the following description taken in conjunction with the drawings.

### BRIEF DESCRIPTION OF DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a partially cut-away perspective view of an electro-mechanical rotating machine shown in the form of a generator including a spacer block in accordance with an exemplary embodiment;

FIG. 2 is a perspective view of a rotor lamination of the generator of FIG. 1;

FIG. 3 is a plan view of a spacer block in accordance with an aspect of the exemplary embodiment;

FIG. 4 is a plan view of the rotor lamination of FIG. 2 with the spacer block of FIG. 3;

FIG. 5 is a perspective view of a spacer block in accordance with another aspect of the exemplary embodiment;

FIG. 6 is a detail view of a portion of the spacer block of FIG. 5;

FIG. 7 is a partial plan view of the rotor lamination of FIG. 2 having first and second spacer blocks in accordance with another aspect of the exemplary embodiment;

FIG. 8 is a side elevational view of the first spacer block of FIG. 7;

FIG. 9 is a side elevational view of the second spacer block of FIG. 7;

FIG. 10 is a partial perspective view of the rotor lamination of FIG. 2 having first and second pluralities of spacer blocks in accordance with yet another exemplary embodiment;

FIG. 11 is a partial perspective view of the rotor lamination of FIG. 10 without the first and second pluralities of spacer blocks;

FIG. 12 is a perspective view of one of the first and second pluralities of spacer blocks of FIG. 10

FIG. 13 is a perspective view of a spacer block in accordance with another aspect of the exemplary embodiment;

FIG. 14 is a plan view of a spacer block in accordance with yet another aspect of the exemplary embodiment;

FIG. 15 is a perspective view of a spacer block in accordance with still another aspect of the exemplary embodiment;

FIG. 16 is a plan view of a spacer block in accordance with yet still another aspect of the exemplary embodiment; and

FIG. 17 is a perspective view of a spacer block in accordance with still yet another aspect of the exemplary embodiment.

The detailed description explains embodiments of the invention, together with advantages and features, by way of example with reference to the drawings.

### DETAILED DESCRIPTION OF THE INVENTION

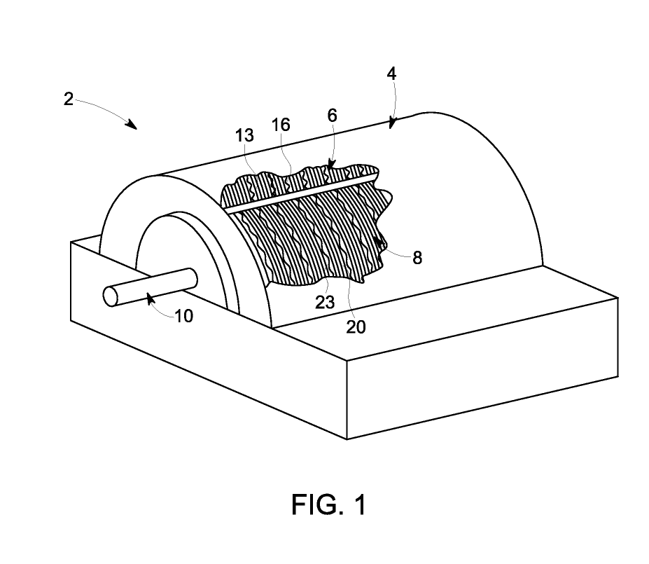

An electro-mechanical rotating machine shown in the form of a generator constructed in accordance with the exemplary embodiment is indicated generally at 2 in FIG. 1. Generator 2 includes a housing 4 that surrounds a stationary member or stator 6 and a moveable member or rotor 8. Rotor 8 is coupled to a shaft 10 that is driven by an external mechanism. That is, rotor 8 is rotated relative to stator 6 so as to convert mechanical energy input through shaft 10 to an electrical output. Stator 6 is formed from a plurality of stator lamination members, one of which is indicated at 13. Select ones of the stator lamination members 13 are spaced one from the other by a number of stator spacer blocks, one of which is indicated at 16. Stator spacer blocks 16 form passageways within stator 6 for cooling fluid to exchange heat with stator lamination members 13. Similarly, rotor 8 is formed from a plurality of rotor lamination members 20. Select ones of rotor lamination members 20 are spaced one from another by rotor spacer blocks 23 to form cooling fluid passageways. As will be detailed more fully below, stator spacer blocks 16 are secured to select ones of stator lamination members 13 without using a thermal bonding process. Likewise, rotor spacer blocks 23 are secured to select ones of rotor lamination members 20 without using a thermal bonding process.

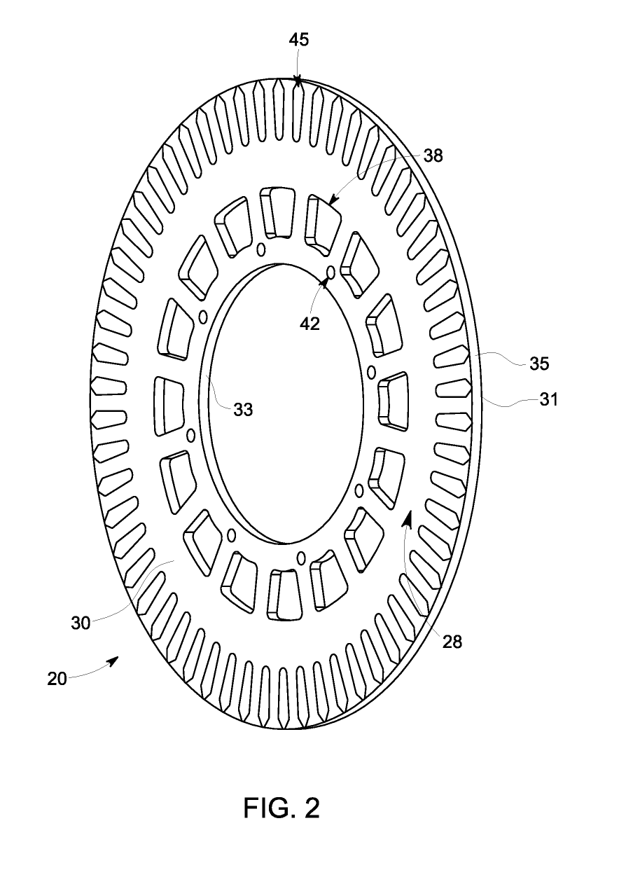

Reference will now be made to FIG. 2 in describing one of rotor lamination members 20. Rotor lamination member 20 includes a body 28 having first and second opposing surfaces 30 and 31 that define an inner annular edge 33 and an outer annular edge 35. A plurality of openings 38 extend through first and second opposing surfaces 30, 31 and are arrayed about rotor lamination 20. Openings 38 provide a pathway for cooling fluid to flow through rotor 8. Rotor lamination member 20 is also shown to include a plurality of passages or mounting features, one of which is indicated at 42 that are arrayed about inner annular edge 33. Mounting features 42 provide a passage for mechanical fasteners, such as bolts, that extend through rotor 8 and join rotor laminations 20. Rotor lamination member 20 is also seen to include a plurality of magnetic field members 45 arrayed about outer annular edge 35. Magnetic field members 45 are configured to induce a magnetic field in stator 6 when rotor 8 is rotated.

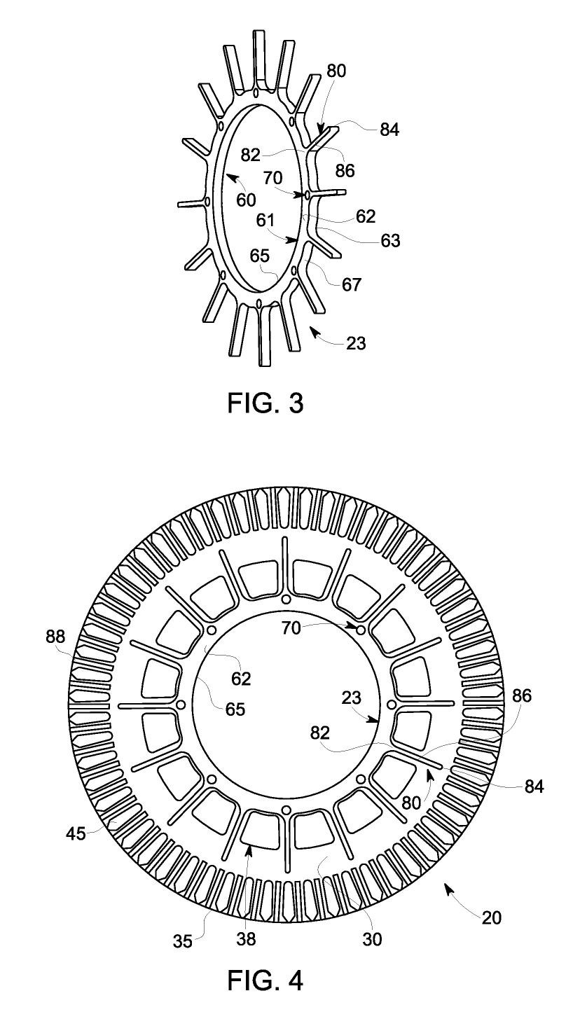

Reference will now be made to FIG. 3 in describing rotor spacer block 23 in accordance with one aspect of the exemplary embodiment. Spacer block 23 includes a base spacer portion 60 that defines an annular ring 61. Spacer block 23 includes first and second opposing lamination surfaces 62 and 63 that define an inner edge portion 65 having a generally concave curvilinear profile and an outer edge portion 67 having a generally convex curvilinear profile. At this point it should be understood that a lamination surface is a portion of the spacer block that faces one of two opposing laminations. Spacer block 23 is also shown to include a plurality of mounting elements 70 arrayed base spacer portion 60 between inner and outer edge portions 65 and 67. Mounting elements 70 take the form of openings (not separately labeled) that extend through first and second lamination surfaces 62, 63. Mounting elements 70 are configured to register with mounting features 42 on rotor lamination member 20. With this arrangement, spacer block 23 is fixed relative to rotor lamination 20 by the fasteners (not shown) that extend through rotor 8.

Spacer block 23 also includes a plurality of spacer finger members 80 that project radially outward from base spacer portion 60. Of course it should be realized, that if spacer member 23 were incorporated into a stator, the plurality of spacer finger members 80 would project radially inward from base spacer portion 60. Regardless, each of the plurality of spacer finger members 80 includes a first end 82 that extends to a second end 84 through an intermediate portion 86. Alternating ones of spacer finger members 80 are radially aligned with corresponding ones of mounting elements 70. When installed on rotor lamination 20 such as shown in FIG. 4, spacer finger members 80 extend between adjacent ones of openings 38 so as to define fluid pathways that guide cooling fluid radially outward from rotor 8. Rotor lamination 20 may also include additional spacers 88 arranged between adjacent ones of magnetic field members 45.

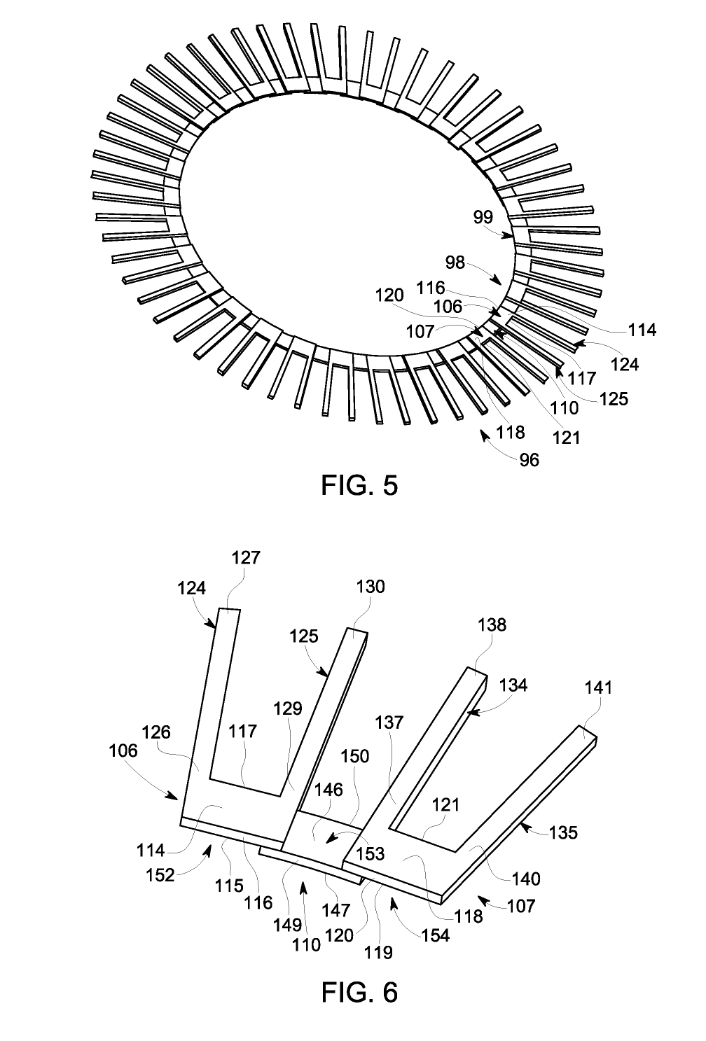

Reference will now follow to FIGS. 5-6 in describing a rotor spacer block 96 in accordance with another aspect of the exemplary embodiment. Spacer block 96 includes a base spacer portion 98 that defines an annular ring 99. Base spacer portion 98 is formed by a plurality of base spacer members, two of which are indicated at 106 and 107, joined by a plurality of connecting spacer portions, one of which is shown at 110. Base spacer member 106 includes first and second lamination surfaces 114 and 115 that define an inner edge portion 116 and an outer edge portion 117. Likewise, base spacer member 107 includes first and second lamination surfaces 118 and 119 that define an inner edge portion 120 and an outer edge portion 121. Each inner edge portion 116 and 120 defines between about 10° to about 15° of a circumference of inner annular edge 33. Base spacer member 106 includes first and second spacer finger members 124 and 125. Spacer finger member 124 includes a first end 126 that extends from outer edge portion 117 to a second end 127. Likewise, spacer finger member 125 includes a first end 129 that extends from outer edge portion 117 to a second end 130. Base spacer member 107 includes first and second spacer finger members 134 and 135. Spacer finger member 134 includes a first end 137 that extends from outer edge portion 121 to a second end 138. Likewise, spacer finger member 135 includes a first end 140 that extends from outer edge portion 121 to a second end 141. Spacer finger members 124, 125, 134, and 135 define fluid flow pathways within rotor 8.

In accordance with the exemplary embodiment shown, first and second base spacer members 106 and 107 are joined by connecting spacer portion 110. Connecting spacer portion 110 includes first and second opposing surface portions 146 and 147 that define a first or inner edge section 149 and a second or outer edge section 150. Inner edge section 149 includes a generally concave curvilinear profile and outer edge section 150 includes a generally concave curvilinear profile. First surface portion 146 is joined with second lamination surface 115 of base spacer member 106 and second lamination surface 119 of base spacer member 107. Connector spacer portion 110 may also be provided with a mounting element (not shown) configured to register with one of mounting features 42 on rotor lamination 20. A subsequent connector spacer member (not separately labeled) is joined to opposing sides of subsequent base spacer members (also not separately labeled) so as to define alternating channels 152, 153, and 154 in base spacer portion 98. Channels 152-154 provide additional passages for channeling cooling fluid flow through rotor 8 when spacer block 96 is mounted to rotor lamination 20.

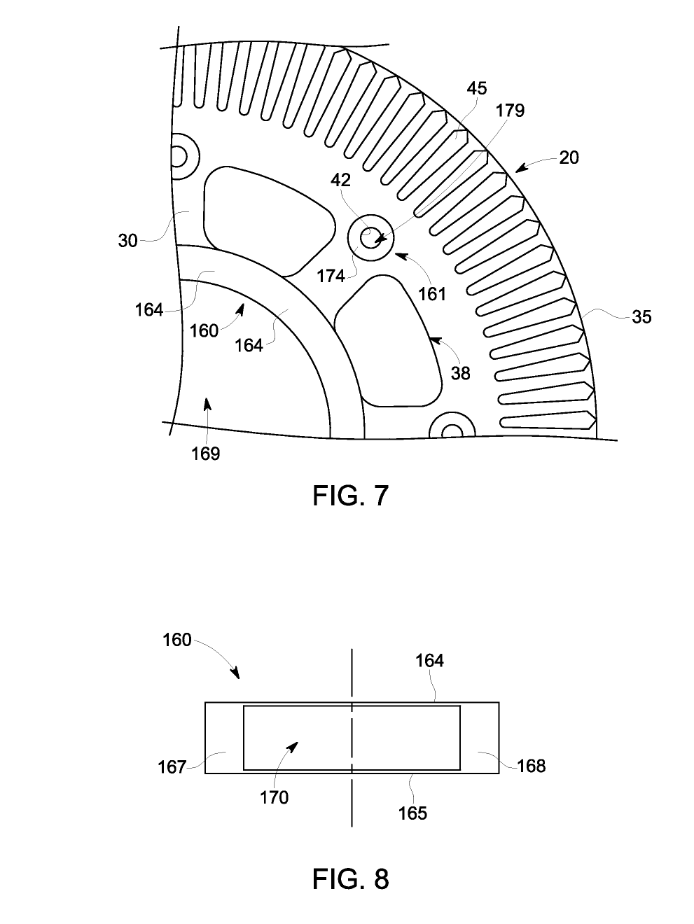

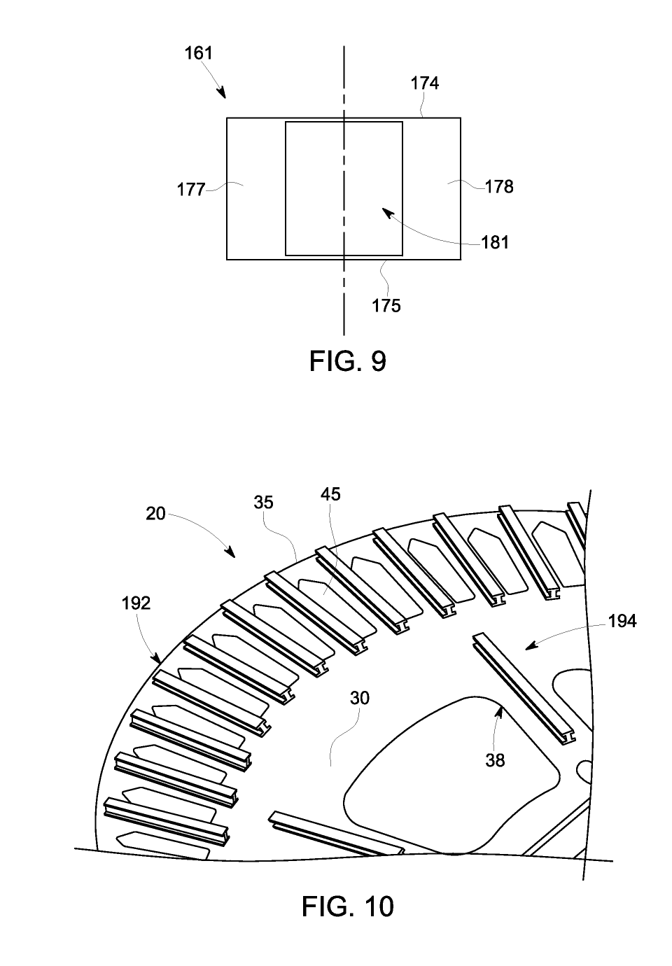

Reference will now follow to FIGS. 7-9 in describing first and second spacer blocks 160 and 161 in accordance with another aspect of the exemplary embodiment. As shown, first spacer block 160 extends about inner edge portion 65 (FIG. 2). First spacer block 160 also extends axially from first surface 30. More specifically, first spacer block 160 includes a first spacer element 164 separated from a second spacer element 165 by first and second side wall elements 167 and 168. A first central opening 169 extends through first and second spacer elements 164 and 165. A first passage 170 is defined between first and second side wall elements 167 and 168. First passage 170 extends transversely to central opening 169. Second spacer block 161 is positioned about each mounting feature 42 (FIG. 2) on lamination member 20. Second spacer member 161 includes first and second spacer portions 174 and 175 separated by first and second side wall portions 177 and 178. A second central opening 179 extends through first and second spacer portions 177 and 178. A second passage 181 is defined between first and second side wall portions 177 and 178. Second passage 181 extends transversely to second central opening 179. With this arrangement, first and second spacer members 160 and 161 provide channeling for cooling fluid to pass along first lamination surface 62 and along to additional lamination members 20 of rotor 8.

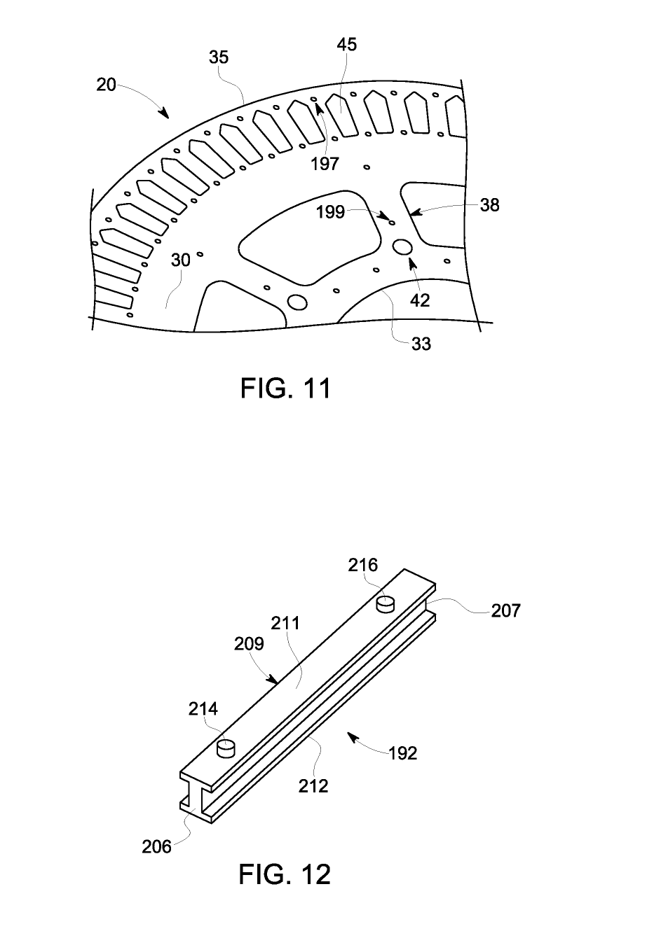

Reference will now be made to FIGS. 10-11 in describing first and second pluralities of spacer blocks 192 and 194 in accordance with yet another aspect of the exemplary embodiment. Each of the first plurality of spacer blocks 192 is arranged between adjacent ones of magnetic field members 45. In contrast, each of the second plurality of spacer blocks 194 is arranged between adjacent ones of openings 38. Thus, in accordance with the exemplary aspect shown, rotor lamination 20 includes a first plurality of mounting features 197 arranged between adjacent ones of magnetic field members 45 and a second plurality of mounting features 199 arranged between adjacent ones of openings 38. Mounting features 197 and 199 extend along a radius of lamination member 20.

As each of the first and second pluralities of spacer blocks 192 and 194 include similar structure, a detailed description will follow with reference to FIG. 12 in describing one of the first plurality of spacer blocks 192 with an understanding that each of the second plurality of spacer blocks 194 is similarly formed. Spacer block 192 includes a first end portion 206 that extends to a second end portion 207 through a generally linear intermediate portion 209. Spacer block 192 includes a first lamination surface 211 and a second, opposing, lamination surface 212. First lamination surface 211 is provided with first and second mounting elements 214 and 216 that are configured to register with mounting features 197. In this manner, spacer blocks 192 and 196 can be mounted to lamination member 20 without using a thermal bonding process.

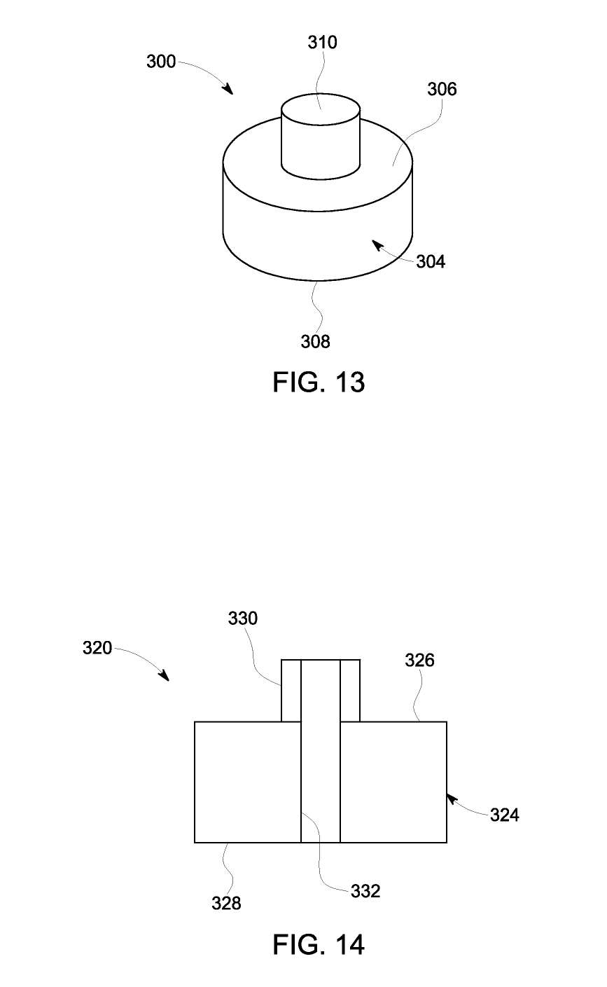

A spacer block in accordance with another aspect of the exemplary embodiment is indicated generally at 300 in FIG. 13. Spacer block 300 is configured to be positioned at, for example, one or more of mounting features 197 and 199. More specifically, spacer block 300 includes a body 304 including a first lamination surface 306 and an opposing second lamination surface 308. First lamination surface 306 is provided with a mounting element 310 configured to nest within, for example, mounting feature 197, while second lamination surface 308 abuts a surface of an adjacent lamination (not shown). FIG. 14 illustrates a spacer block 320 configured to mount to, for example, mounting feature 42. Spacer block 320 includes a body 324 having a first lamination surface 326 and an opposing second lamination surface 328. First lamination surface 326 is provided with a mounting element 330 that is configured to nest within mounting feature 42. In order to allow spacer block to receive a fastener, or pass a flow of coolant, spacer block 320 includes a central passage 332.

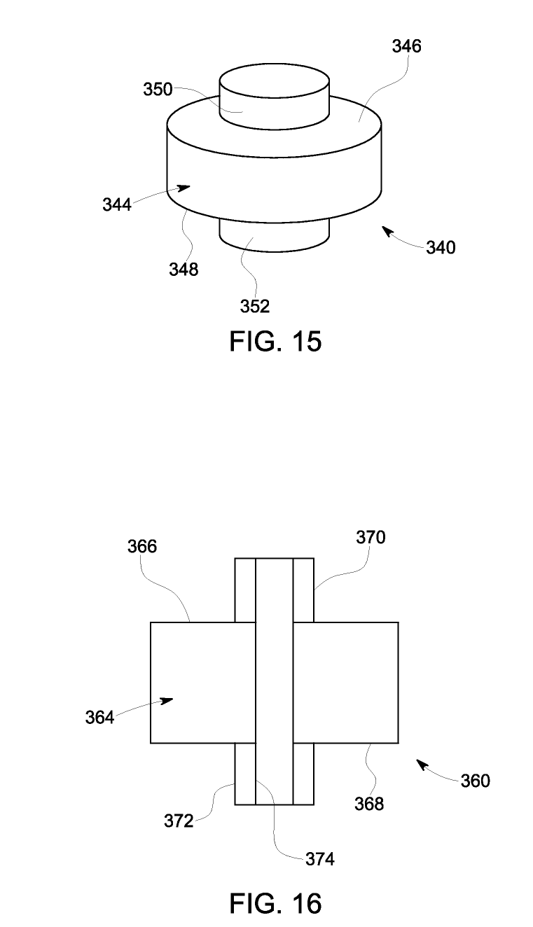

FIG. 15 illustrates a spacer block 340 in accordance with still another aspect of the exemplary embodiment. Spacer block 340 is configured to be positioned at, for example, one or more of mounting features 197 and 199. More specifically, spacer block 340 includes a body 344 including a first lamination surface 346 and an opposing second lamination surface 348. First lamination surface 346 is provided with a first mounting element 350 configured to nest within, for example, mounting feature 197, while second lamination surface 348 is provided with a second mounting element 352 configured to nest within a mounting feature (not shown) of an adjacent lamination (also not shown). FIG. 16 illustrates a spacer block 360 configured to mount to, for example, mounting feature 42. Spacer block 360 includes a body 364 having a first lamination surface 366 and an opposing second lamination surface 368. First lamination surface 366 is provided with a first mounting element 370 that is configured to nest within mounting feature 42 and second lamination surface 368 is provided with a second mounting element 372 configured to nest within a mounting feature (not shown) on an adjacent lamination (also not shown). In order to allow spacer block to receive a fastener, or pass a flow of coolant, spacer block 360 includes a central passage 374.

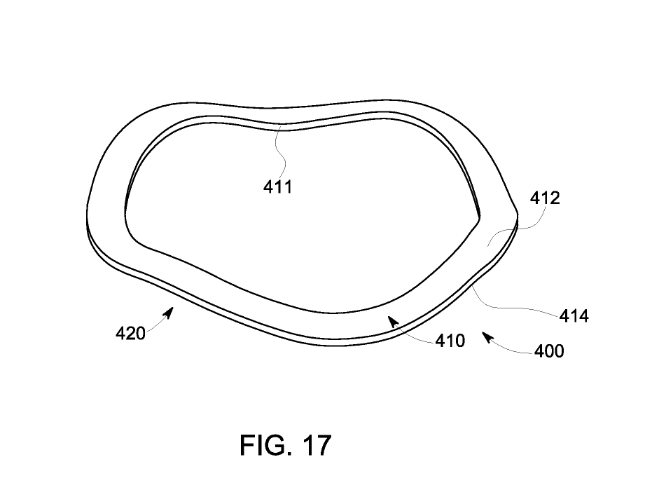

FIG. 17 illustrates a spacer block 400 in accordance with yet still another aspect of the exemplary embodiment. Spacer block 400 may be provided about inner annular edge 33 or about mounting feature 42. Spacer block 400 includes a body 410 that defines an annular ring 411 having a first lamination surface 412 and a second opposing lamination surface 414. Body 410 includes a number of bends, one of which is shown at 420 that create a wave-like profile for spacer block 400. Bends 420 provide passages that allow cooling fluid to pass between adjacent laminations.

At this point it should be understood that the exemplary embodiment provides various spacer blocks that can be mounted to a lamination member without using a thermal bonding process. That is, the spacer blocks of the present invention include structure that is configured to engage with various features on the lamination member to form a bond. In this manner, thermal bonding process, such as welding, brazing and the like can be avoided. Avoiding thermal bonding leads to various advantages in the construction of a lamination stack. For example thermal bonding processes increase construction costs, present various risks in causing damage to a lamination and/or a spacer block and add to an overall construction time. Avoiding thermal bonding processes leads to lower construction costs, fewer risks of damage and shortens construction time. It should also be understood that the electro-mechanical rotating machine should not be limited to a generator and may take on a variety of forms including motors and the like

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. An electro-mechanical rotating machine spacer block comprising:
at least one base spacer portion having first and second lamination surfaces separated by an inner edge portion and an outer edge portion, the inner edge portion including a concave curvilinear profile and the outer edge portion including a convex curvilinear profile; and
a plurality of spacer finger members integrally formed with and extending radially from one of the inner and the outer edge portions.

2. The electro-mechanical rotating machine spacer block according to claim 1, wherein the at least one base spacer portion includes at least one mounting element arranged on at least one of the first and second lamination surfaces, the mounting element being configured and disposed to matingly engage with an adjacent lamination member.

3. The electro-mechanical rotating machine spacer block according to claim 2, wherein the at least one mounting element comprises an opening extending through the first and second lamination surfaces.

4. The electro-mechanical rotating machine spacer block according to claim 3, wherein the at least one mounting element comprises a plurality of mounting elements, each of the plurality of spacer finger members being radially aligned with a corresponding one of the plurality of mounting elements.

5. The electro-mechanical rotating machine spacer block according to claim 1, wherein the at least one base spacer portion defines an annular ring.

6. The electro-mechanical rotating machine according to claim 5, wherein the annular ring includes one or more bend portions that establish a wave-like profile.

7. The electro-mechanical rotating machine spacer block according to claim 1, wherein the at least one base spacer portion and the plurality of spacer finger members are stamped from a metal sheet.

8. The electro-mechanical rotating machine spacer block according to claim 1, wherein the at least one base spacer portion includes at least two base spacer members, each of the at least two base spacer members including corresponding first and second lamination surfaces.

9. The electro-mechanical rotating machine spacer block according to claim 8, further comprising: at least one connector spacer portion joining the at least two base spacer members, the at least one connector spacer portion including first and second opposing surface portions joined by first and second edge sections, the first edge section including a concave curvilinear profile and the second edge section including a concave curvilinear profile.

10. The electro-mechanical rotating machine spacer block according to claim 9, wherein one of the first and second opposing surface portions is connected with one of the first and second lamination surfaces of the at least two base spacer members.

11. The electro-mechanical rotating machine spacer block according to claim 10, wherein the at least one connector spacer portion is integrally formed with the at least two base spacer members.

12. The electro-mechanical rotating machine spacer block according to claim 11, wherein each of the at least two base spacer members includes an inner edge portion and an outer edge portion, the inner edge portion of one of the at least two base spacer members defines between about 10° and about 15° of the inner edge portion.

13. The electro-mechanical rotating machine spacer block according to claim 1, wherein the plurality of spacer finger members extend radially from the outer edge portion.

14. The electro-mechanical rotating machine spacer block according to claim 1, wherein the electro-mechanical rotating machine spacer block is configured to be joined to an electro-mechanical rotating machine lamination without employing a thermal bonding process.

15. An electro-mechanical rotating machine comprising:
a lamination member having first and second opposing surfaces defining an inner annular edge and an outer annular edge, the lamination member including one or more openings extending through the first and second opposing surfaces, and one or more mounting features; and
a plurality of spacer blocks joined to one of the first and second opposing surfaces through the mounting features without a thermal bonding process.

16. The electro-mechanical rotating machine according to claim 15, wherein the one or more mounting features include at least two mounting features that extend along a radius of the lamination member.

17. The electro-mechanical rotating machine according to claim 16, wherein each of the plurality of spacer blocks include a first end portion that extends to a second end portion through a generally linear intermediate portion having first and second opposing surfaces, at least one of the first and second opposing surfaces including at least two mounting elements configured and disposed to interact with the at least two mounting features.

18. The electro-mechanical rotating machine according to claim 15, wherein the plurality of spacer blocks includes a first spacer block arranged about the inner annular edge and one or more second spacer blocks arranged about corresponding ones of the one or more openings.

19. The electro-mechanical rotating machine according to claim 18, wherein the first spacer block includes a first spacer element joined to a second spacer element through first and second side wall elements and a first central opening formed in the first and second spacer elements, and the second spacer block includes a first spacer portion joined to a second spacer portion through first and second side wall portions and a second central opening extending through the first and second spacer portions.

20. The electro-mechanical rotating machine according to claim 19, wherein the first spacer block includes a first passage defined between the first and second side wall elements and the second spacer block includes a second passage defined between the first and second side wall portions, the first passage extending transversely to the first central opening and the second passage extending transversely to the second central opening.
